(19) United States
(12) Patent Application Publication
(10) Pub. No.: US 2009/0040172 A1
(43) Pub. Date: Feb. 12, 2009

(54) Liquid crystal display and the backlight indicating apparatus and method thereof

(75) Inventors: Shui-Chih Lien, Hsin-Chu (TW); Chi-Mao Hung, Hsin-Chu (TW)

Correspondence Address: RABIN & Berdo, PC, 1101 14TH STREET, NW, SUITE 500, WASHINGTON, DC, 20005, US

(73) Assignee: AU OPTRONICS CORP., Hsin-Chu (TW)

(21) Appl. No.: 12/078,504

(22) Filed: Apr. 1, 2008

(30) Foreign Application Priority Data
Aug. 6, 2007 (TW) 96128901

(51) Int. Cl. G09G 3/36

(52) U.S. Cl. 345/102

(57) ABSTRACT

A liquid crystal display has a backlight module and an indicator. The indicator is used to detect the light brightness of the backlight module, and announces a warning when the light brightness is lower than a predetermined value. The indicator has at least one color light detection unit that includes a detector, an analog-to-digital converter (ADC), a controller and a warning display. The detector detects the brightness of a color light from the backlight module to generate a light brightness voltage. The ADC converts the light brightness voltage into a digital signal. The controller determines whether the brightness of the color light is lower than the predetermined value or not according to the digital signal. When the brightness of the color light is lower than the predetermined value, the controller makes the warning display announce the warning.

### RELATED APPLICATIONS

This application claims priority to Taiwan Patent Application Serial Number 96128901, filed Aug. 06, 2007, which is herein incorporated by reference.

### BACKGROUND OF THE INVENTION

1. Field of Invention

The invention relates to a liquid crystal display and, in particular, to a liquid crystal display with an indicating apparatus for automatically indicating the state of its backlight module.

2. Related Art

Liquid crystal displays (LCDs) have the advantages of good image quality, small volume, lightness, low driving voltage, low power consumption, and wide applications. Therefore, they are largely used in middle- to small-size portable televisions (TVs), mobile phones, video cameras, notebook computers, desktop displays, projection TVs, as well as other computer-related products. The display quality of the LCD, such as the natural colors, high color saturation, high brightness, and high contrast, has become an important feature demanded by users.

Current techniques utilize the gamma correction, color temperature control, or color images to adjust the colors in images. However, these color adjusting methods have to be performed under stable backlight conditions. If the backlight state is not stable enough, the color adjusting methods become impractical and meaningless. Nevertheless, currently there is no LCD that can,self-check its backlight condition and report to its user.

### SUMMARY OF THE INVENTION

An objective of the invention is to provide an LCD that contains a backlight module and an indicating apparatus. The indicating apparatus detects the light brightness of the backlight module and issues a warning when the light brightness is lower than a predetermined value.

Another objective of the invention is to provide an indicating apparatus for the LCD. The disclosed indicating apparatus includes at least one color light detection unit that includes a detector, an analog-to-digital converter (ADC), a controller, and a warning display. The detector detects the brightness of a color light of the backlight module, and generates a light brightness voltage. The ADC converts the light brightness voltage into a digital signal. The controller determines whether the light brightness of the color light is lower than a predetermined value. If the color light brightness is below the predetermined value, the control sends out a warning via the warning display.

A further objective of the invention is to provide a light brightness indicating method for the LCD. The method includes the steps of: detecting the light brightness of a color of a backlight module to generate a light brightness voltage; converting the light brightness voltage into a digital signal; determining whether the light brightness of the color light is below a predetermined value according to the digital signal; and sending out a warning when the color light brightness is below the predetermined value.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view of the LCD according to an embodiment of the invention;

FIG. 2 is a flowchart of the light brightness indicating method for an LCD according to an embodiment of the invention;

FIG. 3 is a schematic view of the LCD according to another embodiment of the invention; and

FIG. 4 is a schematic view of the LCD according to yet another embodiment of the invention.

### DETAILED DESCRIPTION OF THE INVENTION

The present invention will be apparent from the following detailed description, which proceeds with reference to the accompanying drawings, wherein the same references relate to the same elements.

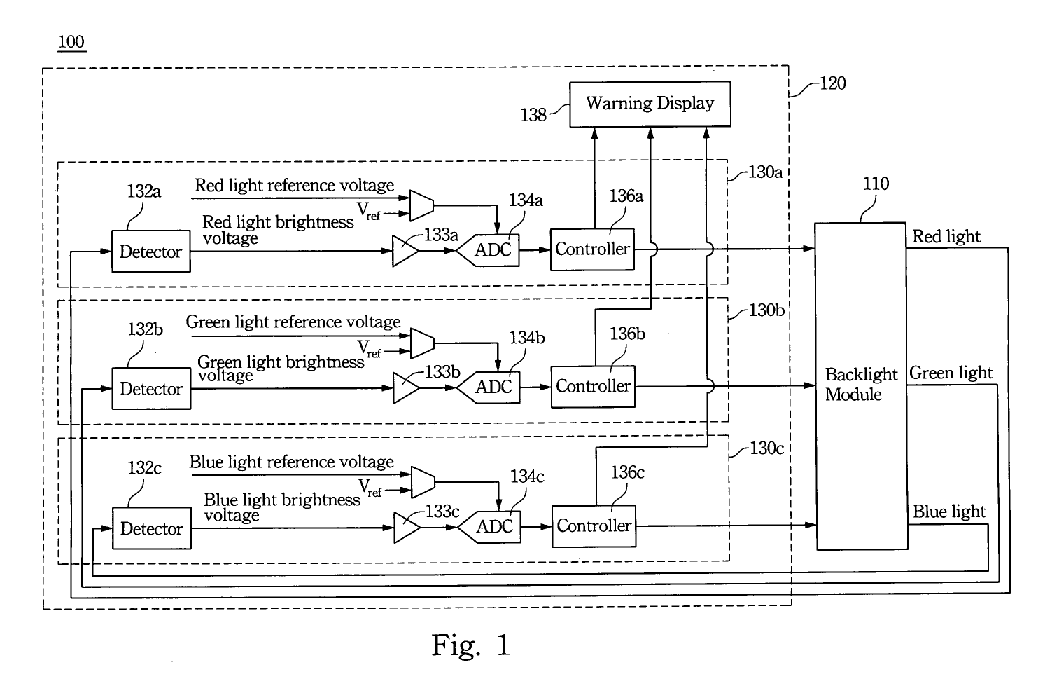

FIG. 1 is a schematic view of the LCD according to an embodiment of the invention. The LCD 100 has a backlight module 110 and an indicating apparatus 120. The indicating apparatus 120 detects the light brightness of the backlight module 110 and issues a warning when the light brightness is lower than a predetermined value.

The indicating apparatus 120 includes at least one light detection unit, such as a red light detection unit 130a, a green light detection unit 130b and a blue light detection unit 130c. Each light detection unit 130a (or 130b, 130c) includes a detector 132a (or 132b, 132c), an ADC 134a (or 134b, 134c), a controller 136a (or 136b, 136c), and a warning display 138. It should be mentioned that the shared warning display 138 in this embodiment is drawn outside the frame of the three color light detection units 130a, 130b, 130c to simplify the drawing.

In the following, the red light detection unit 130a is used to explain its operating process. The detector 132a detects the red light emitted by the backlight module 110 and generates a red light brightness voltage accordingly. The ADC 134a converts the red light brightness voltage into a digital signal. Afterwards, the controller 136a determines whether the red light brightness of the backlight module 110 is lower than a predetermined value. When the red light brightness is lower than the predetermined value, the controller 136a sends out a warning via the warning display 138.

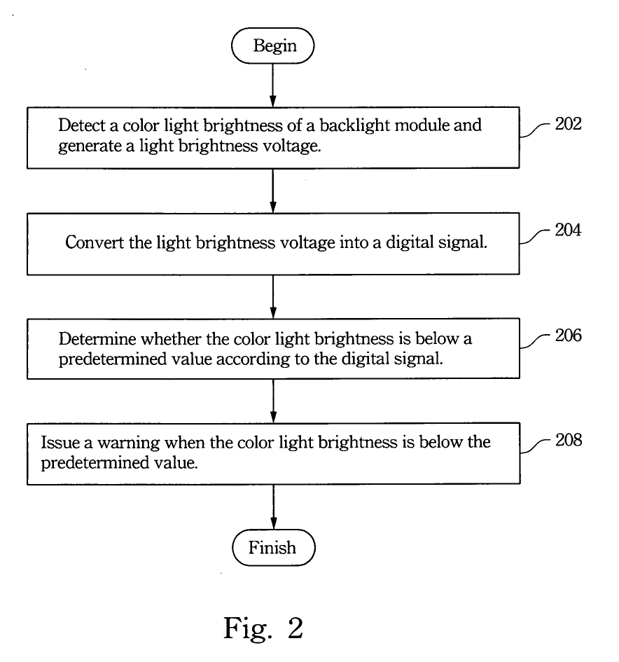

Moreover, this embodiment also provides a light brightness indicating method for the LCD. FIG. 2 is a flowchart of the disclosed light brightness indicating method. First, the brightness of a color light of a backlight module is detected and generates a light brightness voltage (step 202). The light brightness voltage is then converted into a digital signal (step 204). Afterwards, the digital signal determines whether the color light brightness is lower than a predetermined value (step 206). When it is lower than the predetermined value, a warning is issued (step 208).

In this embodiment, the ADC 134a (or 134b, 134c) coverts the light brightness voltage into a digital signal according to the reference voltage of the corresponding color (i.e., the red, green, or blue light reference voltage). The light brightness voltage of each color can first be processed by a program amplifier 133a (or 133b, 133c) before it is sent to the ADC 134a (or 134b, 134c) for a comparison with the above-mentioned reference voltage. The controller 136a (or 136b, 136c) used in this embodiment is also equipped with a function to adjust the color light brightness of the backlight module 100 according to the digital signal. More explicitly, the original backlight module controlling circuit can be modified to implement the color light brightness adjusting function. In this case, when the variation in the color light brightness of the backlight module 100 is small, the controller 136a (or 136b, 136c) can adjust the color light brightness by changing the pulse width modulation (PWM) signal or increase the signal voltage. When the variation in the color light brightness of the backlight module 100 becomes too large, the controller 136a (or 136b, 136c) makes the warning display 138 send out a warning message.

The warning display 138 can be a light-emitting diode (LED), an on-screen-display (OSD) image generator, a warning program, or some other hardware or software warning display device. For example, the LED can be directly disposed on the case of the LED to send warnings by emitting a light or a flashing signal. The OSD image generator can be integrated in the LCD to send out warnings on its screen. Alternatively, a warning program can be installed in the computer host or some other electronic device connected with the LCD. When the computer host or electronic device is in use, a warning is displayed or recorded in a record file. Moreover, the warning can be sent via a network to a remote end.

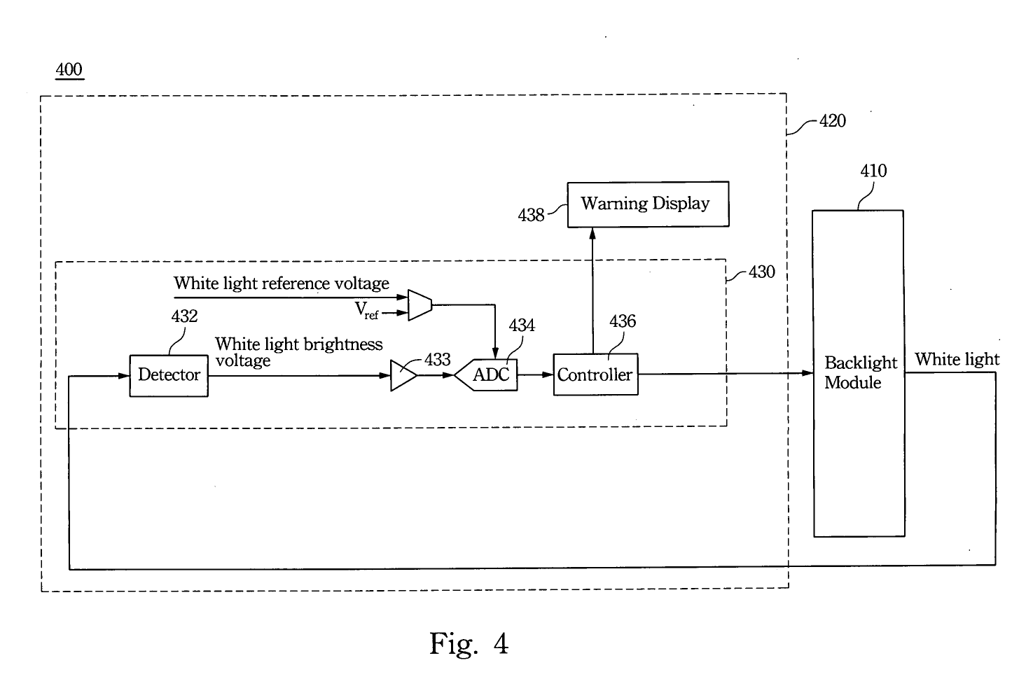

In the prefer embodiment, the backlight module 110 can be a cold cathode fluorescent lamp (CCFL) or an LED backlight module. Moreover, the backlight module 110 can be a monochromic or multi-color backlight module. FIG. 4 shows the LCD according to another embodiment of the invention. Its backlight module 410 is the conventional CCFL backlight module that provides white light. The LCD 400 includes a backlight module 410 and an indicating apparatus 420. The indicating apparatus 420 detects the light brightness of the backlight module 410 and sends out a warning when the light brightness is below a predetermined value. The indicating apparatus 420 has a white light detection unit 430 that includes a detector 432, an ADC 434, a controller 436, and a warning display 438.

The detector 432 detects the white light emitted by the backlight module 410 and generates a white light brightness voltage according to the brightness of the white light. Afterwards, the ADC 434 converts the white light brightness voltage into a digital signal. In particular, a programmed amplifier 433 can initially process the white light brightness before the white light brightness is sent to the ADC 434 to be compared with the white light reference voltage. The controller 436 then determines whether the white light brightness is below a predetermined value according to the digital signal. When the white light brightness is below the predetermined value, the controller 436 sends the warning display 438 a signal and a warning is issued.

The indicating apparatus 120 in FIG. 1 can be entirely or partially disposed in a printed circuit board (PCB), data driver chip, scanning driver chip or other compatible circuit of the LCD. As described above, the structure of the indicating apparatus 120 can be readily integrated with the original circuit of the LCD. This can save a lot of cost in design and production.

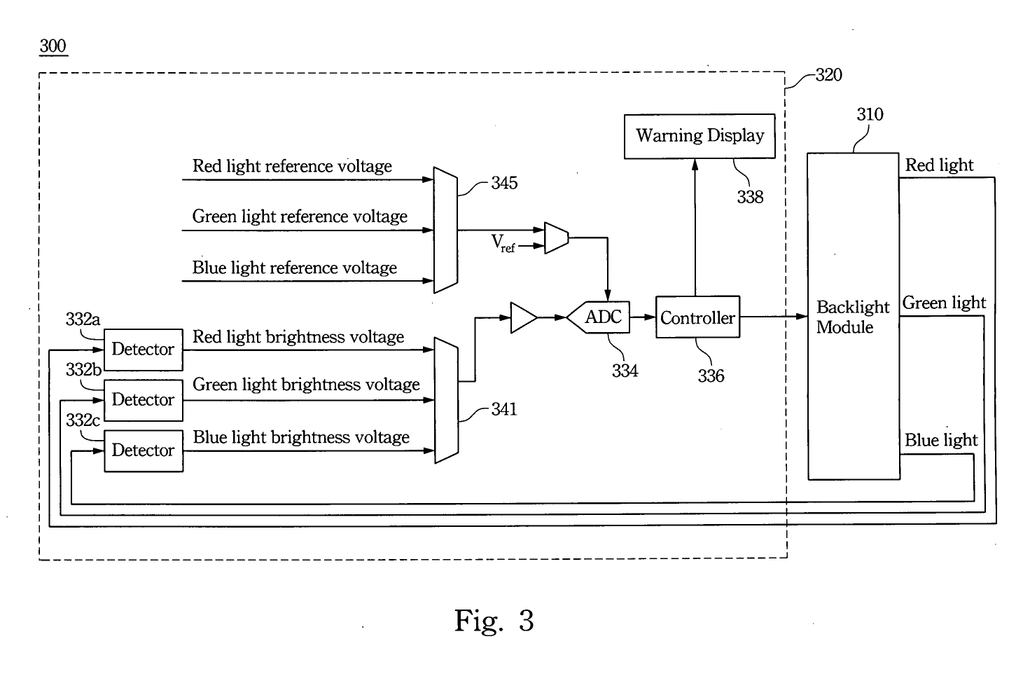

FIG. 3 is a schematic view of the LCD in another embodiment of the invention. The LCD 300 includes a backlight module 310 and an indicating apparatus 320. The indicating apparatus 320 has at least one color light detection unit, which is implemented by combining multiplexers 341, 345 in this embodiment. The detectors 332a, 332b, 332c respectively detect the red, green, and blue light emitted by the backlight module 310 and generate red, green, and blue light brightness voltages according to their brightness. Afterwards, the multiplexers 341, 345 switch to select a particular color brightness voltage and the corresponding reference voltage, such as the red light brightness voltage and the red light reference voltage. They are input into the ADC 334 for a conversion into a digital signal. The controller 336 then determines whether the light brightness of this color is below a predetermined value according to the digital signal. When it is below the predetermined value, the controller 336 makes the warning display 338 send out a warning.

In other words, the devices included in different color light detection units can be shared or devoted. They can be implemented by software or hardware. Thus, the invention is not restricted by the embodiments mentioned herein.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display (LCD), comprising:
a backlight module; and
an indicating apparatus for detecting the light brightness of the backlight module and issuing a warning when the light brightness is below a predetermined value.

2. The LCD of claim 1, wherein the indicating apparatus has at least one color light detection unit that includes:
a detector for detecting the light brightness of a color light of the backlight module and generates a light brightness voltage;
an analog-to-digital converter (ADC) for converting the light brightness voltage into a digital signal;
a controller for determining whether the color light brightness is below the predetermined value according to the digital signal; and
a warning display adapted to be controlled by the controller to issue the warning when the color light brightness is below the predetermined value.

3. The LCD of claim 2, wherein the ADC is adapted to convert the light brightness voltage into the digital signal according to a reference voltage for the color light.

4. The LCD of claim 2, wherein the controller is configured to adjust the output light brightness of the backlight module according to the digital signal.

5. The LCD of claim 2, wherein the warning display comprises a light-emitting diode, an on-screen-display image generator, or a warning program.

6. The LCD of claim 2, wherein the indicating apparatus further includes at least one multiplexer to switch between different modes for detecting the light brightness of different colors of the backlight module.

7. The LCD of claim 1, wherein the backlight module comprises a cold cathode fluorescent lamp, or a light-emitting diode.

8. The LCD of claim 1, further comprising a printed circuit board, wherein the indicating apparatus is disposed on the printed circuit board.

9. The LCD of claim 1, further comprising a data driver chip, wherein the indicating apparatus is disposed in the data driver chip.

10. The LCD of claim 1, further comprising a scanning driver chip, wherein the indicating apparatus is disposed in the scanning driver chip.

11. An indicating apparatus for use in a liquid crystal display (LCD), comprising:
at least one color light detection unit that include:
a detector configured to detect the light brightness of a color light of the backlight module and generates a light brightness voltage;
an analog-to-digital converter (ADC) adapted to convert the light brightness voltage into a digital signal;
a controller configured to determine whether the color light brightness is below the predetermined value according to the digital signal; and
a warning display adapted to be controlled by the controller to issue the warning when the color light brightness is below the predetermined value.

12. The indicating apparatus of claim 11, wherein the ADC is adapted to convert the light brightness voltage into the digital signal according to a reference voltage for the color light.

13. The indicating apparatus of claim 11, wherein the controller is configured to adjust the output light brightness of the backlight module according to the digital signal.

14. The indicating apparatus of claim 11, wherein the backlight module comprises a cold cathode fluorescent lamp, or a light-emitting diode.

15. The indicating apparatus of claim 11, wherein the warning display comprises a light-emitting diode, an on-screen-display image generator, or a warning program.

16. The indicating apparatus of claim 11, further comprising at least one multiplexer to switching among different modes for detecting the light brightness of different colors of the backlight module.

17. A method for indicating the light brightness of a liquid crystal display (LCD), comprising the steps of:
detecting the brightness of a color light of a backlight module and generating a light brightness voltage accordingly;
converting the light brightness voltage into a digital signal;
determining whether the light brightness of the color light is below a predetermined value; and
issuing a warning when the color light brightness is below the predetermined value.

18. The method of claim 17, wherein the step of converting the light brightness voltage into a digital signal is performed according to a reference voltage associated with the color light.

19. The method of claim 17, wherein issuing the warning comprises utilizing a light-emitting diode, an on-screen-display image generator, or a warning program to realize the warning.

20. The method of claim 17, further comprising the step of switching among different modes for detecting the light brightness of different colors of the backlight module.
